(19) United States
(12) Patent Application Publication
(10) Pub. No.: US 2006/0009938 A1
(43) Pub. Date: Jan. 12, 2006

(54) Digital jitter synthesizer

(75) Inventors: Tseng Roger, Kuei-Shan Hsiang (TW); Chih Chi Wang, Kuei-Shan Hsiang (TW)

Correspondence Address: ANTHONY R. BARKUME, 20 GATEWAY LANE, MANORVILLE, NY, 11949, US

(73) Assignee: CHROMA ATE INC

(21) Appl. No.: 11/158,673

(22) Filed: Jun. 21, 2005

(30) Foreign Application Priority Data
Jul. 8, 2004 (TW) 093120414

(51) Int. Cl. G06F 19/00

(52) U.S. Cl. 702/107

(57) ABSTRACT

A digital jitter synthesizer includes a signal generation unit, a tuning frequency optional unit, and a random option unit. The tuning frequency optional unit is able to output a frequency control value, and leads the signal generation unit tune the frequency of an output signal based on the frequency control value; then the signal with the frequency can be fed back to the random optional unit to lead the tuning frequency optional unit generate the other frequency control value randomly to control the signal generation unit for tuning the output signal to the other frequency then to generate an output signal with jitter effect.

### FIELD OF THE INVENTION

The present invention relates to a jitter synthesizer to generate digital jitter signals and be applied to ATE (Auto Testing Equipment) of integrated circuits.

### BACKGROUND OF THE INVENTION

In general digital circuits with middle and low frequency, they can work well basically although there are several offset or jitter in the signals due to the slow speed. But the signal time will be less than 10 nano-second in the high frequency digital circuits, all the circuit will be fail if there is a little jitter in the signal. Therefore, the issue of signal jitter is more and more important.

The issue of signal jitter is very important in modern integrated circuits. Jitter is an important index of signal stability. If jitter can be well controlled, the operation of high-speed digital integrated circuits will also be very stable, and the performance of circuits will be improved, too.

FIG. 1 describes a jitter signal. The frequency or phase of a signal would have little affection by unstable electrical power, electric-magnetic interference or noise during the output path. That will results in difference on each cycle of the signal; each cycle of the signal will be located in a range tj if we accumulate and fold them, and tj is what we called jitter. Signal jitter is usually distributed in the jitter range tj randomly.

The ATE (Auto Testing Equipment) of semiconductor usually is able to test the signal jitter tj, but the input signal for testing usually is an ideal input signal and the generated jitter tj would be the result after circuits operating; the testing result is able to verify the stability of circuits if the jitter locates in the tolerance range only but not be able to verify the tolerance of circuits. In other word, we cannot verify the circuit is able to work well or not if the input signal is not ideal and with some jitter. That is, to implement a mechanism to generate controllable jitter for tolerance testing is an important issue, and also be the main consideration of the present invention.

### SUMMARY OF THE INVENTION

An objective of the present invention is to propose a new digital jitter synthesizer to generate signal jitter for jitter tolerance testing of semiconductor auto testing equipments, which includes better frequency resolution, bigger frequency range, and is able to do tuning control for generating signal jitter.

### BRIEF DESCRIPTION OF THE INVENTION

According to the present invention, a digital jitter synthesizer includes a signal generation unit, a tuning frequency optional unit, and a random option unit. The tuning frequency optional unit is able to output a frequency control value, and leads the signal generation unit tune the frequency of an output signal based on the frequency control value; then the signal with the frequency can be fed back to the random optional unit to lead the tuning frequency optional unit generate the other frequency control value randomly to control the signal generation unit for tuning its output signal to the other frequency then to generate an output signal with jitter effect.

In accordance with one aspect of the present invention, the signal generation unit of the digital jitter synthesizer includes a sine wave generator, a low-passed filter and a sine wave to square wave converter; the sine wave generator can generate a sine wave, which will go through the low-passed filter to filter out the high frequency signal; and the sine wave to square wave converter can transfer to a square wave for output.

In accordance with one aspect of the present invention, the tuning frequency optional unit can decide the frequencies of the sine wave and the square wave.

In accordance with one aspect of the present invention, the sine wave generator includes a phase accumulator, a phase to amplitude converter, and a digital to analog converter (DAC); in which the phase accumulator can generate a phase sampling signal by the frequency control value from the tuning frequency optional unit and a reference clock, and converts the sampling signal to a sine-waved amplitude for output via the phase to amplitude converter.

In accordance with one aspect of the present invention, the formula of the phase to amplitude converter is

$$X [ n ] = sin ( 2 π \frac{Φ [ n ]}{{2}^{N}} ) .$$

In accordance with one aspect of the present invention, the tuning frequency optional unit includes a frequency tuning word (FTW) table and a MUX, and be able to select a frequency tuning word (FTW) by the option of the random optional unit; the frequency tuning word can be the frequency control value.

In accordance with one aspect of the present invention, the random optional unit is a pseudo random value generator to generate a random value for controlling the MUX.

In accordance with one aspect of the present invention, the frequency tuning word table is stored in a register file and includes multiple frequency tuning words.

In accordance with one aspect of the present invention, the random optional unit is controlled by the signal from the signal generator unit, and generates an optional signal randomly.

In accordance with one aspect of the present invention, the digital jitter synthesizer is applied to an auto testing equipment (ATE).

In accordance with one aspect of the present invention, the auto testing equipment (ATE) is a VLSI tester system.

The present invention may best be understood through the following description with reference to the accompanying drawings, in which:

### BRIEF DESCRIPTION OF THE DRAWINGS

FIG. 1 shows the diagram of the typical jitter signal; and

FIG. 2 shows the digital jitter synthesizer according to the present invention.

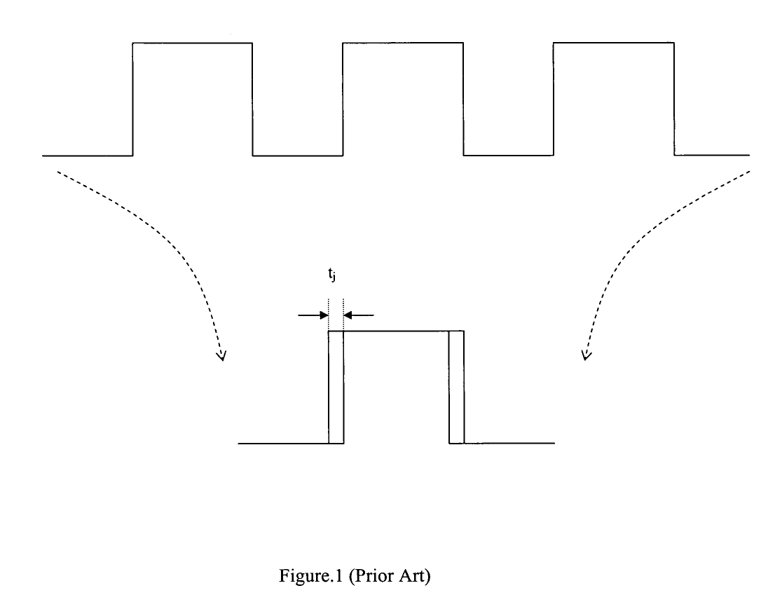

### DETAILED DESCRIPTION OF THE PREFERRED EMBODIMENT

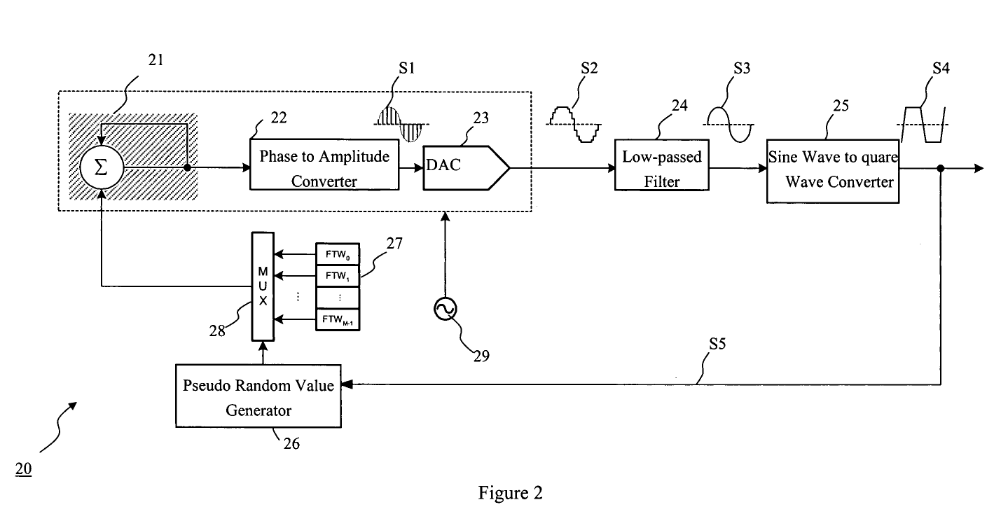

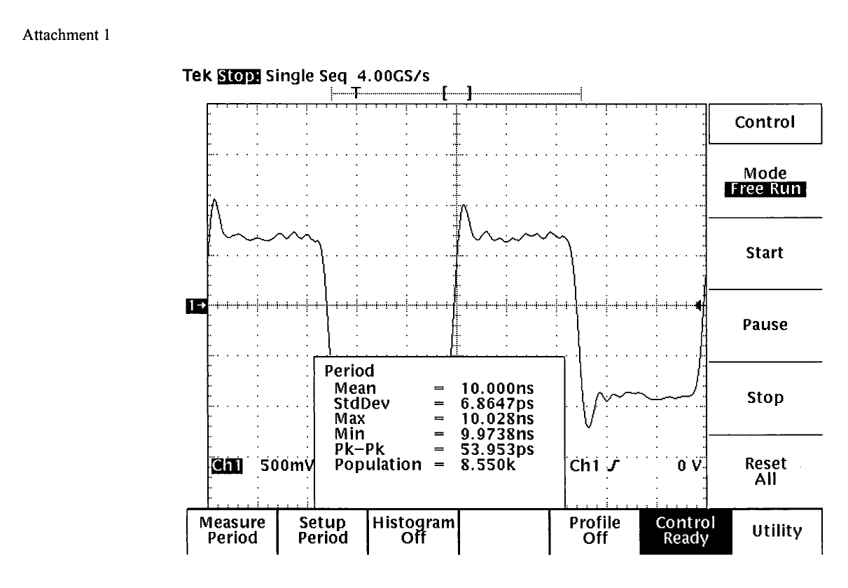

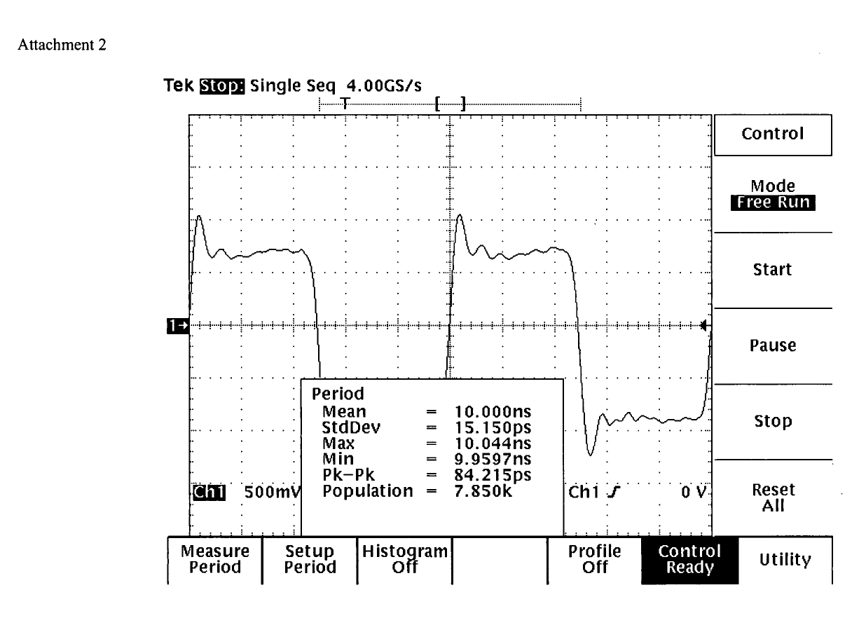

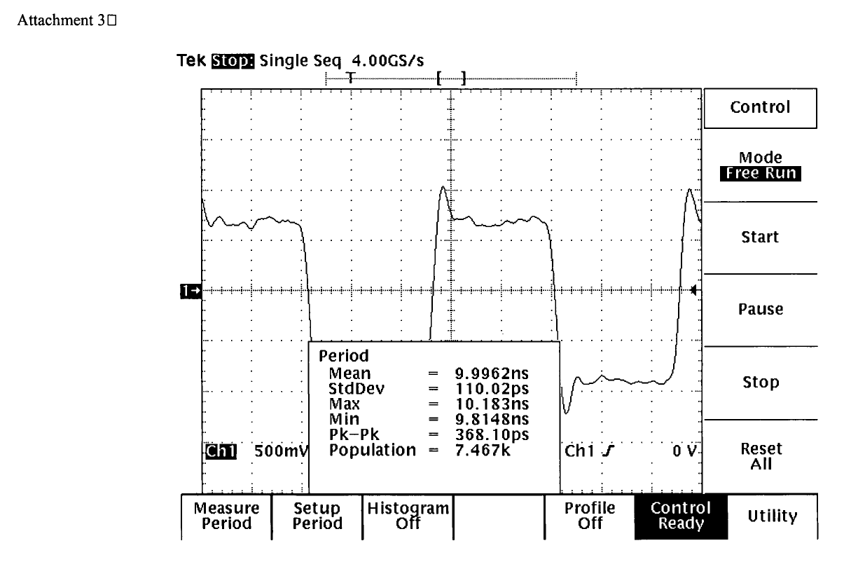

FIG. 2 shows the block diagram of the digital jitter synthesizer 20 according to the present invention. The digital jitter synthesizer 20 includes a phase accumulator 21, a phase to amplitude converter 22, and a digital to analog converter (DAC) 23, a low-passed filter 24, and a sine wave to square wave converter 25, a pseudo random value generator 26, a frequency tuning word (FTW) table 27, a MUX 28, and a reference clock 29.

The phase accumulator 21 is an N-bit binary accumulator, which adds the reference clock 29 into the frequency tuning word. The accumulated result will be provided to the phase to amplitude converter 22 for generating the sampling signal S1 of sine wave. The formula of phase to amplitude converter 22 is as below:

$$X [ n ] = sin ( 2 π \frac{Φ [ n ]}{{2}^{N}} )$$

In above formula, Φ[n]=Φ[n-1]+FTW is the accumulated result of phases. The digital to analog converter 23 (DAC) converts the data stream X[n] to sine analog signal S2. The output of DAC 23 includes high frequency element, which can be filtered by the low-passed filter 24 (LPF), and output the sine wave signal S3. If the frequency tuning word FTW is fixed, the final generated square wave signal will be a central frequency signal, and its frequency is:
F_{C}=FTW□F_{SYSCLK}□2^{N}

Where, F_{SYSCLK} is the frequency of reference clock 29. At last, the signal will be converted to a square wave signal S4 and output by the sine wave to square wave converter.

If the FTW changes with time by an offset frequency tuning word DFTW, that is, FTW+DFTW, then the output frequency will become F_{C}+ΔF, in which ΔF=DFTW□F_{SYSCLK}□2^{N}. The variation ΔF is the jitter in time domain. The quantity of the induced jitter is calculated as:

$${t}_{j} = \frac{1}{{F}_{C} + Δ F} - \frac{1}{{F}_{C}} = \frac{{2}^{N}}{{F}_{SYSCLK}} ( \frac{1}{FTW + DFTW} - \frac{1}{FTW} ) \qquad ( 1 )$$

Above formula (1) can be written as:

$$\frac{- DFTW}{( FTW + DFTW ) FTW} = \frac{{t}_{j} \cdot {F}_{SYSCLK}}{{2}^{N}} \qquad ( 2 )$$

If DFTW<<FTW, then formula (2) can be simplified as:

$$\frac{- DFTW}{{FTW}^{2}} = \frac{{t}_{j} {F}_{SYSCLK}}{{2}^{N}} \qquad ( 3 )$$

At last, DFTW is decided by formula (4) as below if the quantity of jitter and the central frequency are specified:
DFTW=−tⱼ·F_{C}·FTW (4)

If DFTW is changed randomly, then the random behavior of jitter can be achieved. For this purpose, a register file to restore multiple FTW is used as frequency tuning word table 27. The pseudo random value generated by a pseudo random value generator 26 (PRVG) will lead the frequency tuning word be selected randomly.

Attachment 1, 2, and 3 are the period measurement results of the digital jitter synthesizer outputs according to the present invention, which have the minimum, medium, and large jitter, respectively. In these measurement results, N=32, and FTW=0x20000000 in radix of hexadecimal, which implies the central frequency is 100 MHz.

Attachment 1 is the measurement result for DFTW=0, and hence is the minimum jitter (53.953 ps). The ideal jitter should be zero, but there is no jitter free signal in the real world, however. Attachment 2 is the measurement result of DFTW varied between ±0x100000, which implies around 38 ps pk-pk but the measured jitter is 84.215 ps; the value would be the ideal jitter 38 ps pluses with the minimum jitter (53.953 ps). Attachment 3 is the measurement result of DFTW varied between ±0x800000, which implies around 300 ps pk-pk but the measured jitter is 368.10 ps, the value would be the ideal jitter pluses with the minimum jitter.

To be summarized, the characteristics according to the present invention uses a tuning frequency optional unit to output a frequency control value (that is, tuning FTW based on DFTW), and makes a signal generation unit tune the output signal frequency according to the frequency control value; the signal with the frequency can fed back to the random optional unit to lead the tuning frequency optional unit generate the other frequency control value randomly to control the signal generation unit to change the frequency of the signal, so as to output a signal with jitter effect.

Certainly, the signal generation unit includes a sine wave generator, a low-passed filter, and a sine wave to square wave converter. The sine wave generator can generate a sine wave, which will go through the low-passed filter for filtering the high frequency part, and be converted to a square wave for output by the sine wave to square wave converter.

The frequencies of sine wave and square wave are decided by the output of tuning frequency optional unit. The sine wave generator includes a phase accumulator 21, a phase to amplitude converter 22, and a digital to analog converter 23 (DAC). The phase accumulator 21 can generate a phase sampling signal by the frequency control value output from the tuning frequency optional unit (that is FTW) and a reference clock, and the sampling signal can be converted as the output of sine wave amplitude by the phase to amplitude converter.

The formula of phase to amplitude converter is

$$X [ n ] = sin ( 2 π \frac{Φ [ n ]}{{2}^{N}} ) .$$

The tuning frequency optional unit includes a frequency tuning word (FTW) table and a MUX, to select a FTW from the frequency tuning word table by the option of the random optional unit; and the FTW is the frequency control value. The random optional unit is a pseudo random value generator and controls the MUX by generating a random value. The frequency tuning word table is stored in a register file, and includes multiple frequency tuning words (FTW). The random optional unit is controlled by the output signal from the signal generator unit and generates an optional signal randomly. Of course, the digital jitter synthesizer would be applies to an auto testing equipment (ATE) for a VLSI tester system.

To sum up, the digital jitter synthesizer of the present invention can generate controllable jitter signals for jitter tolerance testing and auto testing equipment of semiconductor, and is a new invention for newly applying.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

Attachment 1 □ The measurement result of the minimum jitter of the present invention.

Attachment 2 □ The measurement result of the medium jitter of the present invention.

Attachment 3 □ The measurement result of the large jitter of the present invention.

What is claimed is:

1. A digital jitter synthesizer comprising: a signal generation unit, a tuning frequency optional unit, and a random option unit; said tuning frequency optional unit being able to output a frequency control value, and leading said signal generation unit tune a frequency of an output signal based on said frequency control value; then said output signal with said frequency being fed back to said random optional unit to lead said tuning frequency optional unit generate said other frequency control value randomly to control said signal generation unit for tuning said output signal to said other frequency then to generate an output signal with jitter effect.

2. The digital jitter synthesizer according to claim 1 wherein said signal generation unit of said digital jitter synthesizer includes a sine wave generator, a low-passed filter and a sine wave to square wave converter; said sine wave generator can generate a sine wave to go through said low-passed filter to filter out said high frequency signal; and said sine wave to square wave converter can transfer to a square wave for output.

3. The digital jitter synthesizer according to claim 2 wherein said tuning frequency optional unit can decide said frequencies of said sine wave and said square wave.

4. The digital jitter synthesizer according to claim 2 wherein said sine wave generator includes a phase accumulator, a phase to amplitude converter, and a digital to analog converter (DAC); in which said phase accumulator can generate a phase sampling signal by said frequency control value from said tuning frequency optional unit and a reference clock, and converts said sampling signal to a sine-waved amplitude for output via said phase to amplitude converter.

5. The digital jitter synthesizer according to claim 1 wherein said formula of said phase to amplitude converter is
$$X [ n ] = sin ( 2 π \frac{Φ [ n ]}{{2}^{N}} ) .$$

6. The digital jitter synthesizer according to claim 1 wherein said tuning frequency optional unit includes a frequency tuning word (FTW) table and a MUX, and be able to select a frequency tuning word (FTW) by said option of said random optional unit; said frequency tuning word is said frequency control value.

7. The digital jitter synthesizer according to claim 6 wherein said random optional unit is a pseudo random value generator to generate a random value for controlling said MUX.

8. The digital jitter synthesizer according to claim 6 wherein said frequency tuning word table is stored in a register file and includes multiple frequency tuning words.

9. The digital jitter synthesizer according to claim 6 wherein said random optional unit is controlled by said signal from said signal generator unit, and generates an optional signal randomly.

10. The digital jitter synthesizer according to claim 1 wherein said digital jitter synthesizer is applied to an auto testing equipment (ATE).

11. The digital jitter synthesizer according to claim 10 wherein said auto testing equipment (ATE) is a VLSI tester system.
